(19) United States
(12) Patent Application Publication
(10) Pub. No.: US 2026/0016421 A1
(43) Pub. Date: Jan. 15, 2026

(54) PROBE FOR THE INSPECTION, MAINTENANCE, AND REPAIR OF MACHINES, POWER GENERATORS, TURBINES, AND STEAM GENERATORS

(71) Applicant: viZaar industrial imaging AG, Albstadt (DE)

(72) Inventor: Kersten ZAAR, Albstadt (DE)

(73) Assignee: viZaar industrial imaging AG, Albstadt (DE)

(21) Appl. No.: 18/995,997

(22) PCT Filed: Aug. 7, 2023
(86) PCT No.: PCT/EP2023/071828

§ 371 Date: Jan. 17, 2025

(30) Foreign Application Priority Data
Aug. 8, 2022 (EP) 22189271.4

(51) Int. Cl. G01N 21/954; G01M 15/02; G01N 21/88; G01N 27/9013; G01N 27/9093; G02B 23/24; G02B 23/26

(52) U.S. Cl. CPC G01N 21/954; G01M 15/02; G01N 21/8851; G01N 27/902; G01N 27/9093; G02B 23/2476; G02B 23/26; G01N 2021/9546

(57) ABSTRACT

A probe for the inspection, maintenance and repair of machines, power generators, turbines and steam generators includes an elongated, movable probe shaft having a proximal end and a distal end, and a probe head arranged at the distal end of the probe shaft, which is provided with at least one sensor. The probe shaft includes a non-metallic composite material in which at least two elongated hollow bodies made of plastics of the polyimide group are embedded, whereby the elongated hollow bodies extend continuously from the proximal end to the probe head at the distal end of the probe shaft.

The invention relates to a probe for the inspection, maintenance and repair of machines, power generators, turbines and steam generators, comprising an elongated movable probe shaft having a distal end and a proximal end, and a probe head provided with at least one sensor and located at the distal end of the probe shaft.

Probes are used to examine areas of machines, turbines and steam generators that are not easily accessible or visible. In particular, these are cavities or confined spaces in machines, turbines and steam generators. Steam generators are heat exchangers with heating or cooling tubes. Steam generators are used, for example, in nuclear power plants. In such applications, primary fluid heated by the core of the nuclear reactor flows through a bundle of tubes in a steam generator. Secondary fluid, usually water, introduced into the space surrounding the tubes absorbs heat from the tubes. The resulting steam is used to drive turbines.

Known probes have an elongated flexible probe shaft with a proximal end and a distal end. The distal end has a probe head. The probe head has a sensor to examine the device of interest. For example, this may be an image sensor. The image sensor may be part of a camera with an imaging system integrated into the probe head. The camera often comprises CCD or CMOS-based image sensors. These convert optical images into electrical signals. Since there is little or no ambient light entering the cavity, the probe is often provided with a light source that illuminates the cavity to be inspected. In addition, a tool may be mounted on the probe to process the inspected part of a machine, generator, turbine, or steam generator, if necessary under visual control, or to retrieve a foreign object. The probe head can be provided with other sensors, such as temperature or ultrasonic sensors, as an alternative or in addition. The flexible probe shaft allows the probe to be inserted into cavities of any shape, even if the access is angled. The probe shaft usually has one or more channels in which the supply lines for at least one sensor, possibly a light source, or tools are arranged. The signal reflected from a structure to be inspected in the cavity, such as light, is coupled to the sensor of the probe inserted into the cavity and converted into electrical signals by the sensor. The sensor can also be referred to as an encoder or transducer. The proximal end of the probe shaft is usually connected to a signal processing device, such as an image processing system. This signal processing unit processes the electrical signals so that they can be displayed on a visual display unit, such as a monitor, or used to control tools.

To inspect hard-to-reach cavities, probes are provided with a probe head that is movable on the probe shaft, for example by means of a joint or a hinge. The probe head can move relative to the probe shaft. This allows the probe head to be aligned relative to the probe shaft so that the sensor located in the probe head can detect a desired area.

Existing endoscopic probes with a circular cross-section probe shaft are not suitable for inspecting such steam generators or other machines with small spaces between the tubes. The probe shaft must be sufficiently flexible to be inserted into the spaces. However, the disadvantage is that the probe shaft tends to bend downward under the force of its own weight. As a result, certain areas in the steam generator or machine cannot be reached with the probe head.

Because of its operation site, the probe must meet several requirements. The probe shaft must have high axial stability in at least one direction perpendicular to its longitudinal axis so that the distal end of the probe shaft with the probe head does not tilt downward in an undesirable manner. An undesirable tilt of the probe shaft will result in the area to be inspected not being detected by the sensor located in the probe head. Another requirement is that the probe head must be securely connected to the probe shaft so that the probe head cannot come loose from the probe shaft and remain in the cavity to be inspected. Depending on the application, this can have significant disadvantages. In particular, forces can be exerted on the probe head by the structure to be inspected if the probe head is caught or jammed in the structure or if the user initiates a jerky movement of the probe head.

A probe designed as a spray lance for use in steam generators is disclosed in U.S. Pat. No. 5,570,969 A. The probe shaft has a rectangular cross section and is provided with hoses for water supply. The probe head does not have a sensor, but has nozzles through which the water supplied in the probe shaft is delivered to the area around the spray lance. Although the probe is provided with a fiber rope attached to the probe head via a wedge-shaped counterpart, such a rope cannot guarantee that the probe head remains on the probe shaft and does not tear off.

The object of the invention is to provide a probe for the inspection, maintenance and repair of machines, power generators, turbines and steam generators, which has a high axial stability of the probe shaft at least in a first direction perpendicular to the longitudinal axis of the probe shaft, while at the same time having a high flexibility in a second direction perpendicular to the longitudinal axis of the probe shaft, wherein the first and the second direction are different, and wherein the probe head is connected to the probe shaft in a reliable manner such that undesired loosening of the probe head from the probe shaft is excluded or at least the risk is significantly reduced.

This object is achieved by a probe having the features of claim 1. The probe is characterized in that the probe shaft comprises essentially of at least one non-metallic composite material in which at least two elongated hollow bodies made of plastics of the polyimide group are embedded, whereby the elongated hollow bodies extend continuously from the proximal end to the probe head at the distal end of the probe shaft. The elongated hollow bodies are embedded in the non-metallic composite material in such a way that they cannot separate from the composite material. Preferably, they are surrounded on all sides by the composite material. In this case, the hollow bodies can be cast with or bonded to the composite material. The combination of a non-metallic composite material and the polyimide hollow bodies embedded in it ensures that the probe shaft is well stabilized against forces acting perpendicular to the longitudinal axis. As a result, the probe does not tilt downward in an undesirable manner at the operation site, but can maintain a substantially horizontal orientation over at least part of the length of the probe shaft. In addition, the polyimide hollow bodies embedded in the composite material and extending from the proximal end of the probe shaft to the probe head have the property, due to the stability of the material combination, that the probe head is reliably held on the probe shaft and cannot come loose from the probe shaft at the operation site due to the probe being tilted or jammed.

The elongated hollow bodies are arranged in the probe shaft so that their longitudinal axis is parallel to the longitudinal axis of the probe shaft. The hollow bodies are aligned parallel to each other.

Polyimide hollow parts also have other key advantages. Thanks to this material, the cavities can be designed with very thin walls. This means that the hollow bodies are lightweight and that the interior of the hollow bodies can be used to accommodate actuators and/or supply lines for the sensor, any tools, or lighting at the probe head. Due to the thin walls of the hollow bodies, the probe shaft still has a comparatively small cross section, allowing the probe to be easily inserted into cavities. This is especially true for cavities in the heating or cooling tubes of heat exchangers. In addition, the polyimide hollows do not restrict the mobility of the probe shaft in a second direction perpendicular to the longitudinal axis of the probe shaft. The polyimide hollows also have the advantage of a low coefficient of friction. As a result, the supply lines or parts of actuators guided in the hollow bodies slide on the inner surface of the hollow bodies without significant resistance, which facilitates the insertion and removal of the supply lines, actuators or other components in the hollow bodies and increases the mobility of the probe equipped with supply lines, actuators or other components.

According to an advantageous embodiment of the invention, the probe shaft has a substantially rectangular cross-section.

According to another advantageous embodiment of the invention, the rectangular cross-section has a height and a width, whereby the height is at least five times greater than the width of the cross-section. The height is equal to the cross-sectional length. However, to distinguish the cross-sectional length from the length of the probe, the term height is used herein. This shape of the cross-section helps to give the probe increased mobility in a direction perpendicular to its longitudinal axis, which allows the probe to be inserted into cavities past obstacles. This direction of increased mobility is parallel to the short side of the rectangular cross section. In contrast, parallel to the long side of the rectangular cross-section, the mobility of the probe is so severely limited that the probe cannot be significantly lowered in an undesirable manner when aligned horizontally.

In a further advantageous embodiment of the invention, the non-metallic composite material of the probe shaft comprises polyurethane or epoxy resin in semi-elastic final consistency. This material is resistant to external influences at the site of use.

In a further advantageous embodiment of the invention, the non-metallic composite material of the probe shaft is halogen-free.

According to a further advantageous embodiment of the invention, carbon fibers are embedded in the non-metallic composite material of the probe shaft.

According to a further advantageous embodiment of the invention, the carbon fibers form a flat layer in the composite material of the probe shaft, whereby the layer extends from the proximal to the distal end of the probe shaft.

According to another advantageous embodiment of the invention, aramid fibers are embedded in the non-metallic composite material of the probe shaft. Advantageously, the aramid fibers are embedded along the entire length of the probe shaft from the proximal end to the distal end. The aramid fibers increase the tensile strength of the probe. The aramid fibers can be embedded in the composite material in one or more layers. The elongated aramid fibers are preferably oriented in the composite so that they are parallel to the longitudinal axis of the probe. For example, an aramid tape may be embedded in the composite material.

In another advantageous embodiment of the invention, the probe head is movably mounted on the probe shaft.

In another advantageous embodiment of the invention, the probe head is connected to the probe shaft by a hinge, whereby the hinge comprises a head hinge piece arranged on the probe head and a shaft hinge piece arranged on the probe shaft. A hinge axis connecting the head hinge piece to the shaft hinge piece is preferably arranged in a releasable manner so that it can be easily removed for cleaning or maintenance purposes without having to remove other parts.

According to a further advantageous embodiment of the invention, at least one securing cable is arranged in the probe shaft and is used to secure the shaft hinge piece to the probe shaft. This prevents the entire shaft hinge piece from undesirably coming loose from the probe shaft and being lost at the operation site. In particular, it eliminates the possibility of the hinge being torn off the probe shaft when external forces are applied to the probe head, such as when the probe head is jammed in the field. For example, the securing cable can be made of steel, in particular stainless steel, carbon or other fibers.

According to another advantageous embodiment of the invention, the securing cable is guided from the proximal end to the distal end of the probe shaft and back again. Advantageously, it is approximately twice the length of the probe shaft. At its redirection at the distal end of the probe shaft, the securing cable forms a loop which is received in a holding device of the shaft hinge piece. The holding device may be, for example, a through hole, an eye, a hook or a bolt in the shaft hinge piece.

In another advantageous embodiment, the probe head and the head hinge piece are formed in one piece. The probe head and the head hinge piece are made in one piece. This has the advantage that the head hinge piece cannot come loose from the probe head.

Another advantageous feature of the invention is that a spring is incorporated at the distal end of the probe shaft and at the probe head, which is deflected relative to the probe shaft when the probe head is moved and exerts a restoring force on the probe head in the direction of an initial position. The spring adds flexibility to the probe, preventing damage to the probe or object to be analyzed in the event of a collision with an obstacle. The spring also makes it easier to guide the probe along tight radii.

According to another advantageous embodiment of the invention, the spring is formed as a helical spring and is received in one of the elongated hollow bodies. It can extend from the hollow body of the probe shaft into a cavity in the probe head.

Another advantageous feature of the invention is that a stop is arranged on the probe shaft or on the probe head to limit the range of movement of the probe head relative to the probe shaft. This ensures that the angular range in which the probe head can move is limited. Deflection beyond this range is prevented, as this could result in damage to the probe, the sensor, or the supply lines, actuators, or other components located in the hollow bodies.

According to a further advantageous embodiment of the invention, at least one elastic glass fiber epoxy rod is loosely incorporated in one of the elongated hollow bodies. The fiberglass epoxy rod is preferably attached to the shaft hinge piece or to the head hinge piece. Such a rod can prevent the probe shaft from buckling in an undesirable manner. Preferably, the glass rod can be combined with a spring so that both together prevent the probe shaft from buckling.

According to another advantageous embodiment of the invention, the sensor in the probe head is in the form of an image sensor. The image sensor can be part of a camera with a lens and possibly further optical components.

According to a further advantageous embodiment of the invention, a plurality of cameras are arranged in the probe head, the field of view and/or direction of view and/or focal length of which are different. Each of these cameras comprises at least one image sensor.

According to a further advantageous embodiment of the invention, supply lines for the at least one sensor are arranged in at least one of the elongated hollow bodies. These can be electrical lines for the power supply or the signal line, or lines that allow the probe head to be cooled.

According to a further advantageous embodiment of the invention, at least one light source is arranged in the probe head. This can emit light in the visible spectral range. Alternatively or cumulatively, light sources emitting light in the infrared or ultraviolet spectral range can be provided.

According to a further advantageous embodiment of the invention, tools are incorporated in the elongated hollow bodies. For example, this may be a retrieval tool. The tool is inserted into one of the hollow bodies and advanced to the probe head. A cavity or channel may be provided in the probe head which is connected to one of the hollow bodies in the probe shaft. This channel in the probe head preferably has an opening at an end face of the probe head through which the tool can exit the probe head to enable machining.

According to a further advantageous embodiment of the invention, the probe shaft is provided with openings through which the tools are introduced into the elongated hollow bodies. These openings may be located on an end face at the proximal end of the probe shaft or on a side of the probe shaft at a certain distance from the proximal end.

According to a further advantageous embodiment of the invention, a cleaning nozzle is arranged on the probe, which is supplied with a cleaning fluid via the hollow bodies in the probe shaft. The cleaning fluid may be liquid or gaseous.

According to a further advantageous embodiment of the invention, a hose filled with a liquid or gaseous medium is incorporated in one of the elongated hollow bodies for moving or variably stiffening the probe shaft. The hose can also be operated as a pneumatic muscle.

According to another advantageous embodiment of the invention, the probe head is made of high-alloy steel. The probe head is thus resistant to the conditions prevailing at the operation site.

According to a further advantageous embodiment of the invention, the probe head is made of titanium.

According to a further advantageous embodiment of the invention, the probe head is made of acrylic glass.

According to a further advantageous embodiment, a metal housing is disposed at the proximal end of the probe shaft. The metal housing encloses the elongated hollow body embedded in the non-metallic composite material. The housing is preferably secured by one or more connecting bolts extending through the metal housing into one or more holes in the composite material. Preferably, an aramid tape is located in the composite material at this location. This aramid tape is provided with through-holes through which the connecting bolts are inserted. The connecting bolts can be welded to the metal housing to provide a positive fit. The elongated hollow bodies can be joined together in the metal housing to form a plug. The length of the elongated hollow bodies is selected to allow expansion as the probe is coiled, increasing overall flexibility. The ends of the securing cable used to attach and secure the shaft hinge piece can be attached to the metal housing.

According to a further advantageous embodiment of the invention, the sensor is designed as an eddy current sensor and is provided with at least one coil with which material inhomogeneities in machines, generators, turbines or steam generators are detected by generating eddy currents. In this case, the eddy current sensor can be combined with an image sensor, in particular with a camera, or can be arranged on the probe head without an image sensor.

According to a further advantageous embodiment of the invention, the probe shaft has a smooth surface on its outside. This reduces the risk of the probe shaft getting caught or jammed at the operation site.

According to a further advantageous embodiment of the invention, the probe shaft is provided with a profile on its outside, at least in sections. This profile can be used to specifically influence the mobility of the probe shaft in the respective section.

According to a further advantageous embodiment of the invention, the profile has a plurality of elongated depressions and/or elevations running parallel to one another. These may extend over the entire probe shaft or only over a portion of the probe shaft.

According to a further advantageous embodiment of the invention, the elongated depressions and/or elevations are aligned parallel to a longitudinal axis of the probe shaft.

According to a further advantageous embodiment of the invention, the elongated depressions and/or elevations are aligned perpendicular to a longitudinal axis of the probe shaft.

According to a further advantageous embodiment of the invention, the elongated depressions and/or elevations are oriented at an angle other than 0° and 90° relative to a longitudinal axis of the probe shaft.

According to a further advantageous embodiment of the invention, the probe shaft, which is provided with a rectangular cross-section, has different profiles on at least two of its surfaces extending parallel to a longitudinal axis of the probe shaft.

Further advantages and advantageous embodiments of the invention will be apparent from the following description, the drawings and the claims.

### DRAWINGS

The drawings show embodiments of the probe according to the invention. They show

FIG. 1: First embodiment of a probe in side view,

FIG. 2: Perspective view of the greatly shortened probe shaft of the probe shown in FIG. 1,

FIG. 3: Cross-section of the probe shaft of FIG. 2,

FIG. 4: Distal end of the probe shaft shown in FIG. 2 with probe head in longitudinal section,

FIG. 5: Longitudinal section of the probe shaft shown in FIG. 2,

FIG. 6: Probe shaft of a second embodiment,

FIG. 7: Probe shaft of a third embodiment,

FIG. 8: Probe shaft of a fourth embodiment,

FIG. 9: Probe shaft of a fifth embodiment.

### DESCRIPTION OF THE EMBODIMENT

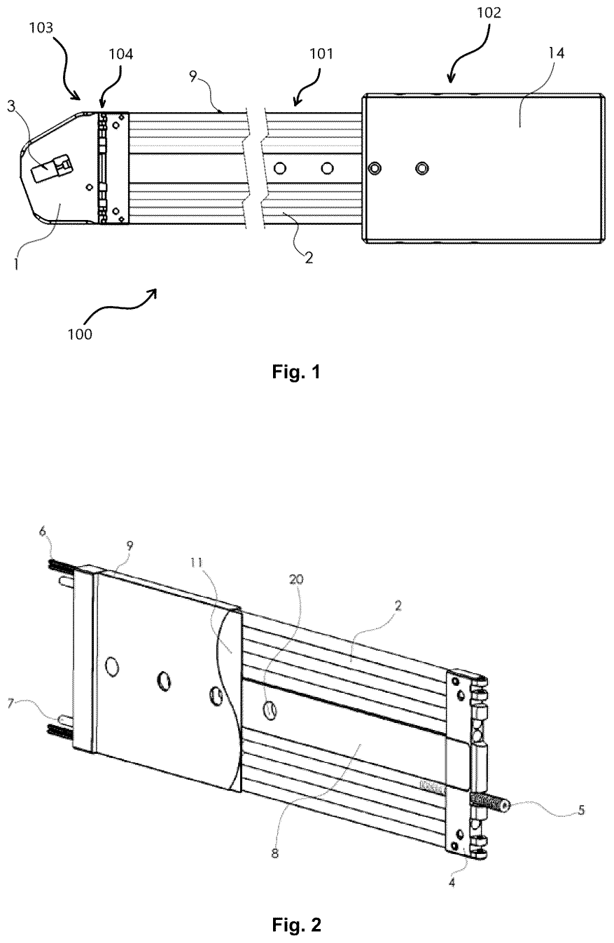

FIGS. 1 to 5 show a probe 100 having a probe shaft 101 and a probe head 1. The probe shaft has a proximal end 102 and a distal end 103. At the distal end 103, the probe head 1 is movably mounted on the probe shaft 101 via a hinge 104. The hinge 104 comprises a shaft hinge piece 4 which is disposed on the probe shaft 101 and is fixedly connected thereto. The hinge 104 also includes a head hinge piece 106, which is part of the probe head 1. The shaft hinge piece 4 and the head hinge piece 106 are connected to each other by means of a connecting bolt 19. At the proximal end of the probe shaft 102, a metal housing 14 is arranged on the probe shaft 101. The probe shaft 101 has a non-metallic composite material 9 in which a total of ten elongated hollow bodies 10 made of polyimide are embedded. In addition, an aramid tape 8 and carbon fibers 11 are embedded in the composite material. The embedding is carried out by casting the composite material, in the embodiment polyurethane or epoxy resin, in a casting process with the hollow bodies 10, the aramid tape and the carbon fibers. The carbon fibers are attached along the hollow bodies for reinforcement prior to casting to ensure stability with the same high flexibility.

FIG. 2 shows the probe shaft 101 greatly shortened so that both the proximal end 102 and the distal end 103 can be seen.

The hollow bodies 10 are arranged in parallel in the probe shaft 101. They allow the direct and straight guidance of various inserts such as securing cables 6, a spring 5, rods 7, electrical conductors 3 and optical conductors not shown in the drawing.

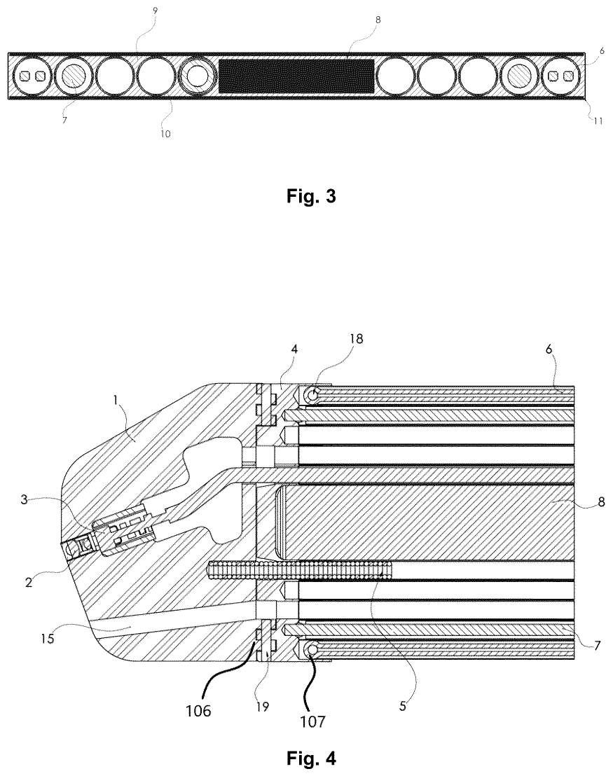

FIG. 3 shows the rectangular cross-section of the probe shaft 101. The figure shows the arrangement of the hollow bodies 10. The hollow bodies 10, which are arranged in parallel, are arranged in two groups of five hollow bodies each, laterally adjacent to the aramid tape 8. The central arrangement of the aramid tape provides stabilization and at the same time connection of the probe shaft 101 with the shaft hinge piece 4 and the metal housing 14 at the proximal end 102. The carbon fibers 11, which are arranged in one or more layers at the top and bottom on or at a short distance from the hollow bodies 10, serve as axial reinforcement. The composite material 9 of polyurethane or epoxy resin surrounds all components and, due to its special material properties, performs an elastic, flexible and reinforcing function.

FIG. 4 shows the distal end 103 of the probe shaft 101 with the probe head 1. The elongated hollow bodies 10 are firmly connected to the shaft hinge piece 4. The securing cables 6 form a loop 107 at the distal end 103, which is received on a bolt 18 of the shaft hinge piece 4. A camera with an integrated image sensor 3 and specially adapted optics 2 is arranged in the probe head 1. A supply line 13 of the camera is guided through one of the hollow bodies 10 to the proximal end 102 of the probe shaft 101. The movement of the probe head 1 relative to the probe shaft 101 is limited by the hinge 104 in a form-locking manner and by the spring 5 in a force-locking manner. The spring 5 is a helical spring. It is held with a first section in one of the hollow bodies 10 of the probe shaft 101 and with a second section in the probe head 1. Deflection of the probe head 1 causes deflection of the spring 5. Its spring force pushes the probe head back to its initial position.

A tool holder 15 is provided in the probe head 1, which is located in the extension of one of the elongated hollow bodies 10. A tool not shown in the drawing can be advanced through the hollow body to the tool holder. For example, pliers, alligator clips or cleaning nozzles can be used as tools. Cleaning nozzles are used to clean hard-to-reach areas in hollows, such as heat exchangers.

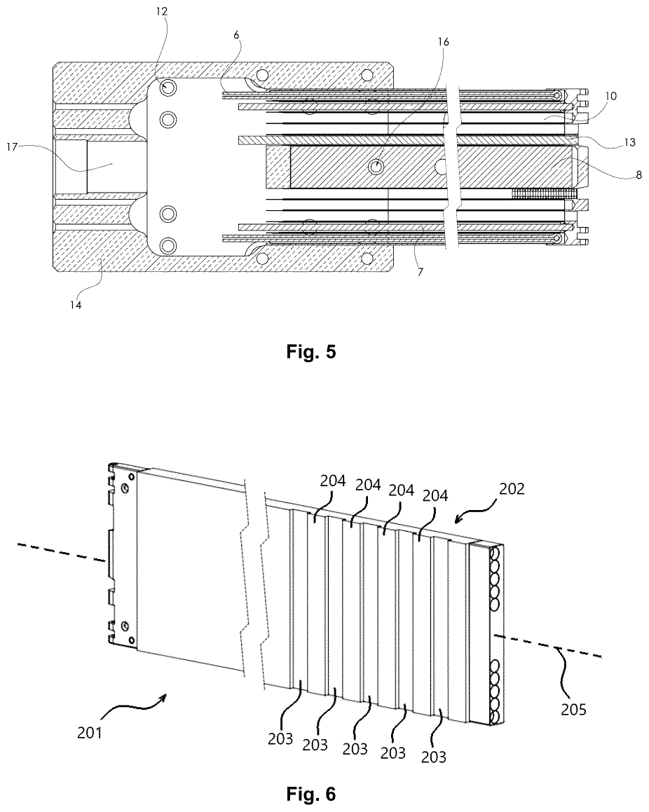

FIG. 5 shows a longitudinal section of the proximal end of the probe shaft. As can be seen, the proximal ends of the elongated hollows are loosely received within the metal body. This provides the hollow bodies with particular flexibility in the axial direction of the probe shaft. The metal housing 14 is attached to the probe shaft 101 by bolts 16 which are inserted into through-openings 20 in the aramid tape 8 and are connected to the metal housing in a form-fitting manner, in particular by welding. The openings 20 in the aramid band can also be used to transport the probe.

The proximal end of the probe shaft serves to bundle the contents of the polyimide hollow body and to receive an electrical connector. The ends of the securing cables 6 are attached laterally to a deflection pin 12. This attachment allows the cables to be extended or retracted and adjusted as desired.

All electrical and/or optical cables and conductors run together at the open end of the metal housing to a cable connector where they are bundled. For this cable connector, which is not shown in the drawing, a recess 17 is provided in the metal housing 14. The cable connector serves as a connection to a vision unit and a display unit, neither of which are shown in the drawing.

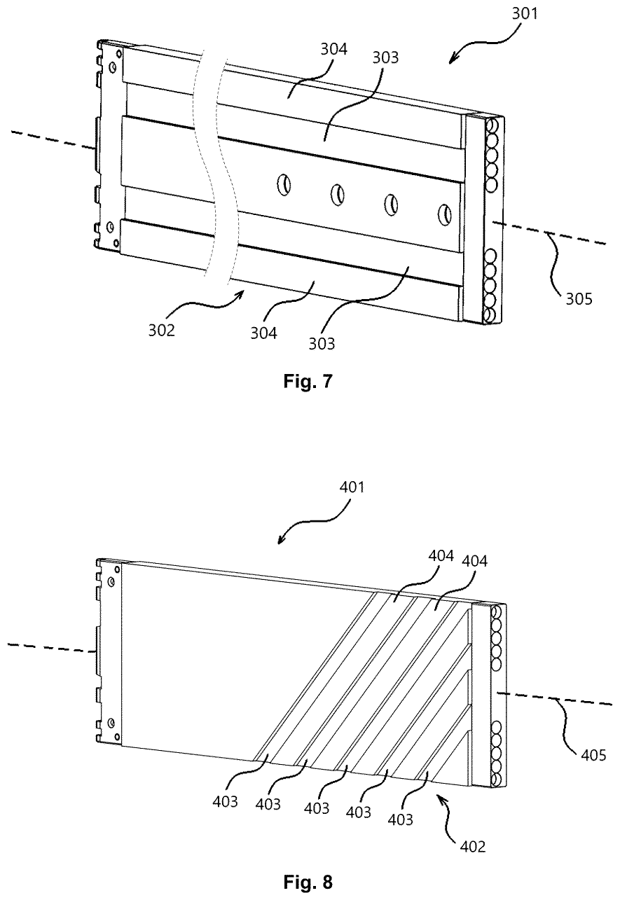

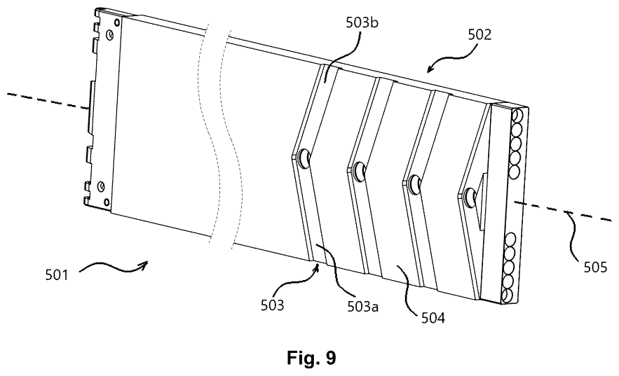

FIGS. 6 to 9 show different examples of probe shaft designs. While the probe shaft 101 of FIGS. 1 to 5 has a smooth surface on the outside, the outside of the probe shaft 201 of FIG. 6, the probe shaft 301 of FIG. 7, the probe shaft 401 of FIG. 8, and the probe shaft 501 of FIG. 9 have different profiles. The probe shafts are shown in abbreviated form in FIGS. 6 to 9. The profile 202 of the probe shaft 201 in FIG. 6 has a plurality of parallel depression 203 and elevations 204 which are oriented perpendicular to the geometric longitudinal axis 205 of the probe shaft 201. The geometric longitudinal axis 205 is indicated by a dashed line. The profile 302 of the probe shaft 301 in FIG. 7 has two elevations 304 and two depressions 303 aligned parallel to the geometric longitudinal axis 305 of the probe shaft 301. The profile 402 of the probe shaft 401 in FIG. 8 is formed by a plurality of parallel depressions 403 and elevations 404 oriented at an angle of approximately 50° relative to the geometric longitudinal axis 405 of the probe shaft. The profile 502 of the probe shaft 501 in FIG. 9 is formed by a plurality of depressions 503, each of the depression 503 being composed of two rectilinear sections 503a, 503b. The two sections 503a, 503b of a depression 503 form an angle of approximately 120°. The angle between the first section 503a and the geometric longitudinal axis 505 of the probe shaft 501 is approximately 60°. The angle between the second section 503b and the geometric longitudinal axis 505 of the probe shaft 501 is also approximately 60°. There is a raised area 504 between each two depressions 503.

All of the features of the invention may be essential to the invention, both individually and in any combination.

### REFERENCE NUMBER LIST

1 Probe head
2 Optical unit
3 Image sensor
4 Shaft hinge piece
5 Spring
6 Securing cable
7 Rod
8 Aramid Tape
9 Composite material
10 Elongated polyimide hollow body
11 Carbon Fiber
12 Bolt for proximal attachment of the securing cable
13 Supply line
14 Metal Housing
15 Tool holder
16 Bolt for attaching the metal housing to the aramid strap
17 Recess for Cable Connector
18 Bolt for distal attachment of the securing cable
19 Connecting Bolt
20 Opening
100 Probe
101 Probe Shaft
102 Proximal End
103 Distal end
104 Hinge
105 Head Hinge
106 Loop
201 Probe Shaft
202 Profile
203 Depression
204 Elevation
205 Probe shaft geometric longitudinal axis
301 Probe shaft
302 Profile
303 Depression
304 Elevation
305 Geometric Longitudinal Axis of the Probe Shaft
401 Probe shaft
402 Profile
403 Depression
404 Elevation
405 Longitudinal geometric axis of the probe
501 Probe shaft
502 Profile
503 Depression
503a Depression section
503b Depression section
504 Elevation
505 Longitudinal geometric axis of the probe shaft

1. A probe for the inspection, maintenance and repair of machines, power generators, turbines and steam generators with an elongated, movable probe shaft (101) having a proximal end (102) and a distal end (103),
with a probe head (1), which is arranged at the distal end (103) of the probe shaft (101) and is provided with at least one sensor (3),
whereby the probe shaft (101) comprises a non-metallic composite material in which at least two elongated hollow bodies (10) made of plastics of the polyimide group are embedded, whereby the elongated hollow bodies (10) extend continuously from the proximal end (102) to the probe head (1) at the distal end (103) of the probe shaft (101).

2. The probe according to claim 1, wherein the probe shaft (101) has a substantially rectangular cross-section.

3. The probe according to claim 2, wherein the rectangular cross-section has a height and a width, whereby the height is at least five times greater than the width of the cross-section.

4. The probe according to claim 1, wherein the non-metallic composite material of the probe shaft (101) comprises polyurethane or epoxy resin in semi-elastic final consistency.

5. The probe according to claim 1, wherein the non-metallic composite material of the probe shaft (101) is halogen-free.

6. The probe according to claim 1, wherein carbon fibers (11) are embedded in the non-metallic composite material of the probe shaft (101).

7. The probe according to claim 6, wherein the carbon fibers (11) form a flat layer in the composite material of the probe shaft (101), whereby the layer extends from the proximal to the distal end of the probe shaft (101).

8. The probe according to claim 1, wherein aramid fibers (8) are embedded in the non-metallic composite material of the probe shaft (101).

9. The probe according to claim 1, wherein the probe head (1) is movably mounted on the probe shaft (101).

10. The probe according to claim 9, wherein the probe head (1) is connected to the probe shaft (101) by a hinge (104), whereby the hinge (104) comprises a head hinge piece (106) arranged on the probe head (1) and a shaft hinge piece (4) arranged on the probe shaft (101).

11. The probe according to claim 10, wherein at least one securing cable (6) is arranged in the probe shaft (101) and is used to secure the shaft hinge piece (4) to the probe shaft (101).

12. The probe according to claim 11, wherein the securing cable (6) is guided from the proximal end (102) to the distal end (103) of the probe shaft (101) and back again, and wherein the securing cable (6) forms at its redirection at the distal end of the probe shaft (101) a loop (107) which is received in a holding device (18) of the shaft hinge piece (4).

13. Probe The probe according to claim 9, wherein a spring (5) is incorporated at the distal end (103) of the probe shaft (101) and at the probe head (1), which is deflected relative to the probe shaft (101) when the probe head (1) is moved and exerts a restoring force on the probe head (1) in the direction of an initial position.

14. The probe according to claim 13, wherein the spring (5) is formed as a helical spring and is received in one of the elongate hollow bodies (10).

15. The probe according to claim 9, wherein a stop is arranged on the probe shaft (101) or on the probe head (1) to limit the range of movement of the probe head (1) relative to the probe shaft (101).

16. The probe according to claim 1, wherein an elastic glass fiber epoxy rod is loosely incorporated in one of the elongate hollow bodies (10), and wherein the glass fiber epoxy rod is attached to the shaft hinge piece (4) or to the head hinge piece (105).

17. The probe according to claim 1, wherein the sensor (3) in the probe head is in the form of an image sensor.

18. The probe according to claim 1, wherein supply lines (13) for the at least one sensor (3) are arranged in at least one of the elongate hollow bodies (10).

19. The probe according to claim 1, wherein at least one light source is arranged in the probe head (1).

20. The probe according to claim 1, wherein tools are incorporated in the elongate hollow bodies (10).

21. The probe according to claim 20, wherein the probe shaft (101) is provided with lateral openings through which the tools are introduced into the elongated hollow bodies (10).

22. The probe according to claim 1, wherein a hose filled with a liquid or gaseous medium under pressure is incorporated in one of the elongated hollow bodies (10) for the variable stiffening of the probe shaft.

23. The probe according to claim 1, wherein the probe head (1) is made of high-alloy steel.

24. The probe according to claim 1, wherein the probe head (1) is made of titanium.

25. Probe The probe according to claim 1, wherein the probe head (1) is made of acrylic glass.

26. The probe according to claim 1, wherein the sensor is designed as an eddy current sensor and is provided with at least one coil with which material inhomogeneities in machines, generators, turbines or steam generators are detected by eddy current generation.

27. The probe according to claim 1, wherein the probe shaft has a smooth surface on its outside.

28. The probe according to claim 1, wherein the probe shaft is provided with a profile on its outside, at least in sections.

29. The probe according to claim 28, wherein the profile has a plurality of elongated depressions and/or elevations running parallel to one another.

30. The probe according to claim 29, wherein the elongated depressions and/or elevations are aligned parallel to a longitudinal axis of the probe shaft.

31. The probe according to claim 29, wherein the elongated depressions and/or elevations are aligned perpendicular to a longitudinal axis of the probe shaft.

32. The probe according to claim 2, wherein the probe shaft is provided with different profiles on at least two of its four surfaces extending parallel to a longitudinal axis of the probe shaft.
